(19) United States
(12) Patent Application Publication
(10) Pub. No.: US 2019/0370925 A1
(43) Pub. Date: Dec. 5, 2019

(54) Decentralized Esports Gaming Token and Wallet

(71) Applicant: Kingsley Edwards, Las Vegas, NV (US)

(72) Inventor: Kingsley Edwards, Las Vegas, NV (US)

(21) Appl. No.: 16/248,138

(22) Filed: Jan. 15, 2019

Related U.S. Application Data
(60) Provisional application No. 62/617,597, filed on Jan. 15, 2018.

(51) Int. Cl. G06Q 50/34; G06F 16/23; G06Q 20/36; G07F 17/32

(52) U.S. Cl. CPC G06Q 50/34; G06F 16/2379; G06Q 20/36; G07F 17/3258; G07F 17/3225; G07F 17/3244; G07F 17/3288

(57) ABSTRACT

An immersive gaming and electronic wagering platform via one or more utility crypto-currency tokens used for the exchange and interchange of a virtual point-based reward system for the purpose of legal and licensed betting on esports matches, tournaments and other engagement around electronic gaming. Users, or players, of the platform may use one or more utility tokens to participate on the platform or to buy one or more products to compete for in-game prizes, such as electronic jackpot tickets.

### CROSS-REFERENCE TO RELATED APPLICATIONS

This application claims the benefit of U.S. Provisional 62/617,597, filed Jan. 15, 2018, which is hereby incorporated by reference as if submitted in its entirety.

### FIELD OF THE INVENTION

The present invention relates to an immersive gaming and electronic wagering platform, and, more particularly, a utility token to be used for the exchange and interchange of a virtual point-based reward system for the purpose of legal and licensed betting on esports matches, tournaments and other engagement around electronic gaming.

### BACKGROUND

With the advance of technology and spread of Internet access, the world is becoming more connected and people have access to nearly any information they seek. The number of internet users has been growing exponentially. Today, over 3.8 billion people has internet access, which is over 50% of the world's population, and this number is expected to rise. Over the past 20 years, the creation and usage of websites has been expanding with widespread access to the internet. The number of websites totaled 1 million in 1997, then reached and maintained at a milestone of 1 billion since 2016.

Another growing trend in the digital world is the development of decentralized trust. Utilizing blockchain technology, payments and/or contracts may be performed via distributed consensus and recorded on a blockchain utilizing different types of tokens. For example, different types of tokens may include security tokens, or asset tokens, utility tokens, or a combination thereof. A blockchain is simply a distributed ledger of all transactions with respect to payments and/or established contracts. Digital coins, or security tokens, such as Bitcoin (BTC) or Ether (ETH) rely on blockchain technology and are much more than a digital currency, but a network of trust that provides the basis for so much more than just currencies. Cryptocurrency, such as BTC or ETH, is a collection of concepts and technologies that form the basis of a digital money ecosystem. Units of currency, such as BTC or ETH, are used to store and transmit value among users in the BTC or ETH network. The cryptocurrency is entirely virtual and is distributed in a peer-to-peer system. Cryptocurrencies typically consist of: a decentralized peer-to-peer network, a published transaction ledger, such as a blockchain, a set of rules for independent transaction validation and currency issuance, and a mechanism for reaching global decentralized consensus on the valid blockchain (such as Proof-of-Work or Proof-of-Stake). In its simplest form, Blockchain is a data structure on which transactional data which are highly resistant to modification may be stored. As a data structure, blockchain is a form of distributed ledger technology that enables data sharing across a network of individual computers.

Benefits to blockchain technology include:

i) that all of the data and transactions that are on the blockchain are difficult to modify or hack; and
ii) that the data itself is transparent.

Esports (also known as electronic sports, e-sports, or eSports) is a form of competition using multiplayer video game competitions. Generally, esports take place professional and/or amateur players and teams. By the 2010s, esports was a significant factor in the video game industry, with many game developers actively designing toward a professional esports subculture. Games typically played include first-person shooter (FPS) games, real-time strategy (RTS) games, or online battle arena games, etc.

### BRIEF SUMMARY OF THE INVENTION

Systems and methods disclosed herein provide an esports entertainment and betting platform. Users, or players, of the platform may use one or more utility tokens to participate on the platform or to buy one or more products to compete for in-game prizes, such as electronic jackpot tickets. Participation on the platform is realized and managed through the utilization of blockchain technology. The utility and asset tokens described herein make it easier and more efficient for users to obtain esports products and services on the platform.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a simplified functional block diagram of a computer system in accordance with the embodiments of the disclosed invention;

FIG. 2 is simplified example of a distributed ledger in accordance with at least one embodiment of the invention; and

FIG. 3 is a block diagram depicting an exemplary environment 300, illustrating a simplified example of how a distributed ledger may be distributed, or replicated, on a network of the disclosed invention;

FIG. 4 illustrates an exemplary distributed ledger in accordance with an embodiment of the disclosed invention;

FIG. 5 illustrates an exemplary diagram of provided functionality in accordance with at least one embodiment of the disclosed invention; and

FIG. 6 illustrates an exemplary networking diagram in accordance with at least one embodiment of the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

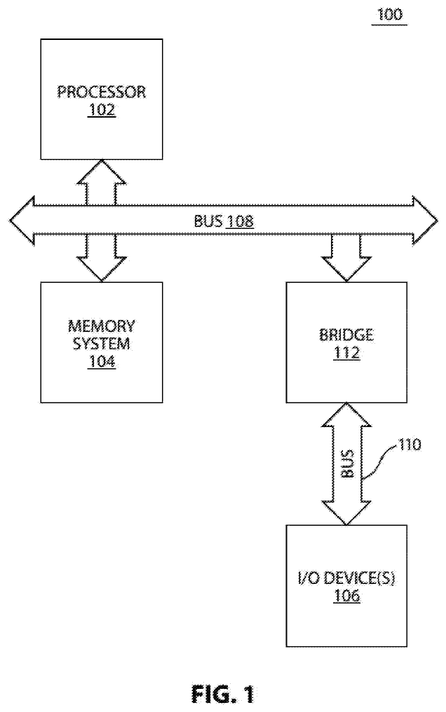

FIG. 1 is an example of a simplified functional block diagram of a computer system 100. The functional descriptions of the present invention can be implemented in hardware, software or some combination thereof.

As shown in FIG. 1, the computer system 100 includes a processor 102, a memory system 104 and one or more input/output (I/O) devices 106 in communication by a communication ‘fabric’. The communication fabric can be implemented in a variety of ways and may include one or more computer buses 108, 110 and/or bridge and/or router devices 112 as shown in FIG. 1. The I/O devices 106 can include network adapters and/or mass storage devices from which the computer system 100 can send and receive data for generating and transmitting advertisements with endorsements and associated news. The computer system 100 may be in communication with the Internet via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

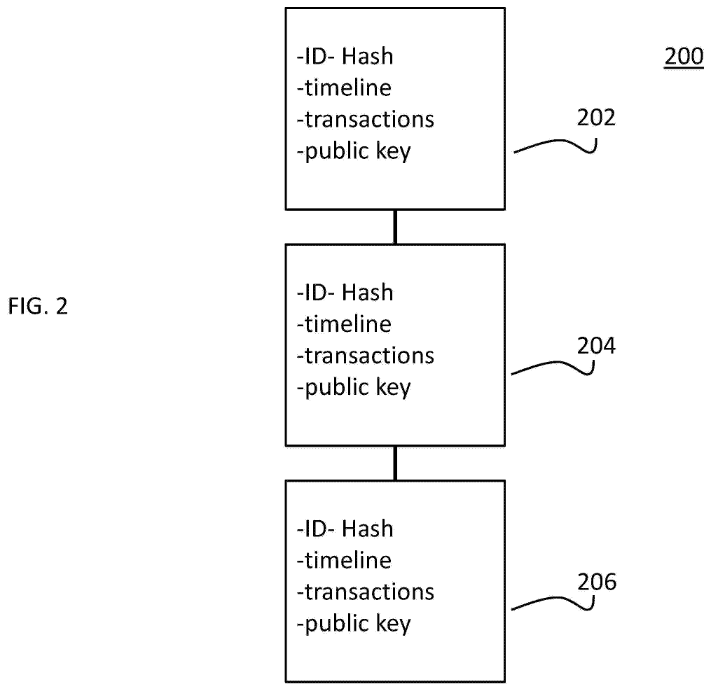

As illustrated in FIG. 2, blockchain 200 is an illustrative example in accordance with at least one embodiment of the invention. Blockchain 200 illustrates a simplified blockchain having 3 blocks, 202, 204, and 206. Block 202 is the first block and is therefore considered to be the genesis block. Each block may include certain information, such as an Identification, or hash, that uniquely identifies the block, a timeline identifying previous blocks (e.g., the hash numbers of previous blocks) in chronological order, transactions to record all transfers between a sender and a receiver, and a public key that identifies at least one sender and at least one receiver. Hash values may be combined into a Merkle tree. The linked blocks therefore form a chain where each link, or block, in the chain uniquely identifies a previous link, or block, by including the hash or the prior link, or block.

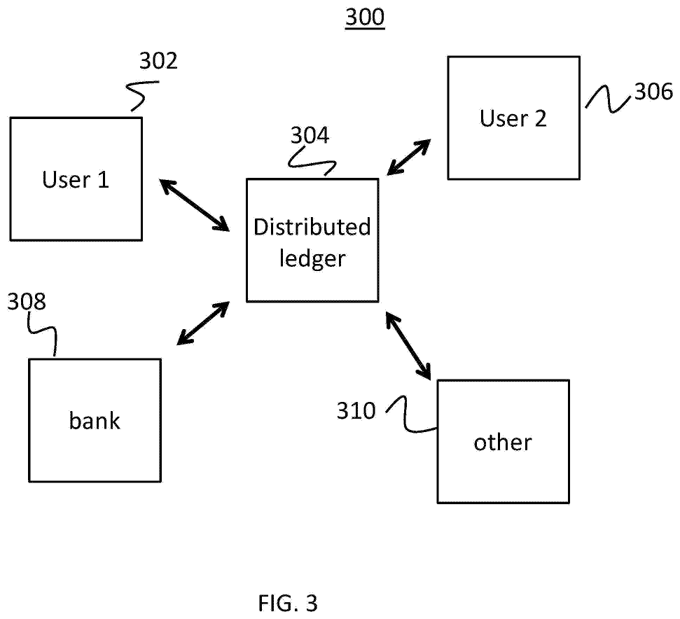

FIG. 3 is a block diagram depicting an example blockchain environment 300, illustrating a simplified example of how a distributed ledger, or blockchain (such as blockchain 200) may be distributed, or replicated, on a network. The distributed ledger may be replicated and maintained on each database within the underlying blockchain's network. Maintenance occurs when consensus is reached between the network's nodes and a new block is added to the chain. Environment 300 may include a first user 302, a second user 304, another entity, such as a bank 308, and another third party entity 310 privy to the blockchain 306, for example a mining node. The first/second user may be a buyer or seller, based on the transaction. Entities may include, but are not limited to, consumers, bankers, merchants, and investors. Blockchain 306 may be replicated in an agreed-upon manner or in real-time (e.g., after each transaction).

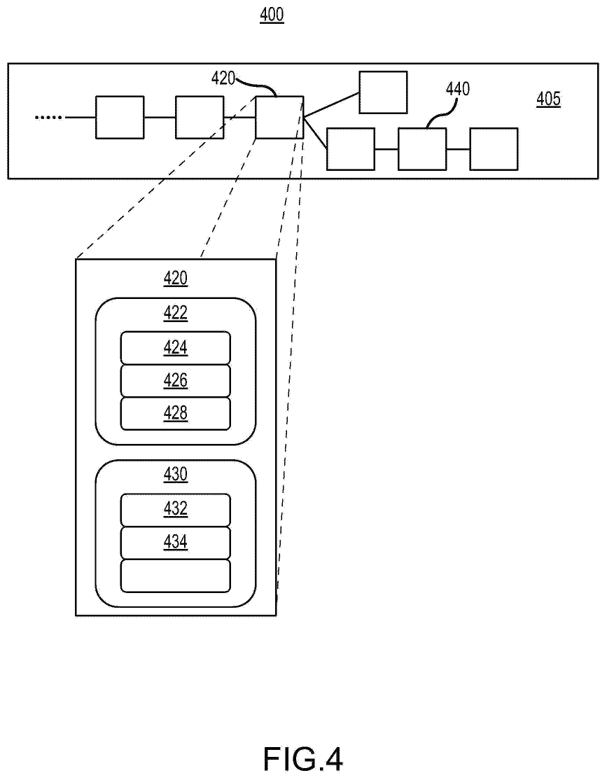

In an embodiment of the present invention, a distributed secure transaction ledger, in the form of a blockchain, may be used to communicate data between parties. As illustrated in FIG. 4, a block chain or decentralized secure transaction ledger 405 may be one that is maintained by nodes in a distributed network. Although each block of ledger 405 may contain differentiated information and may have distinct purposes, as illustrated in FIG. 4, block 410 contains a sample communication or message according to embodiments of the present invention.

In an embodiment of the present invention, ledger 405 may be used to send messages, or conduct transactions, between at least two users of a system through, for example, nodes in a network. By way of non-limiting example only, a message in block 420 of the ledger 405 may contain a header 422 and contents 430. The header 422 may comprises at least one block ID 424 for block 420, a block ID 426 of the previous block, and a nonce value 428, an arbitrary number that may be used as a cryptographic hash function. These values and block information may be used in linking blocks together to form a chain.

The contents 430 may comprise one or more messages 432 and may also include other data 434. In an embodiment on the present invention, a message 432 may comprise a unique identifier of the owner/originator/sender of the message. This information may be used for one or more purposes, such as, for example, to identify the owner or sender to provide a way by which a third-party node or nodes that handle and or process the ledger 405. Additionally, the identifier of the owner/sender may be used or linked to an authentication module and/or server associated with using the block chain as a communication channel, or for other actions. Indeed, block 420 may include any number of identifiers which may for example, be used to indicate whether or not the ledger 405 should be directed to a different identifier than the originator of the message 432. As would be appreciated by those skilled in the art, message 432 may include data for processing, which may be obfuscated using, for example, homomorphy transformation.

In an embodiment of the present invention, ledger 440 may be used to send encrypted and secure messages between users through public systems, private/closed systems, or a combination thereof. Similar to the message(s) in block 420, the contents of ledger 440 may comprises one or more messages and may also comprise other encryption/authentication data. In an embodiment of the present invention, a message contained in ledger 440 may comprise a unique identifier of the recipient of the message, which may be the originator of the initial message or another entity. The message may include a unique identifier of the node that submitted the message. Such may be used for one or more purposes. For example, the identifier may help identify who sent the message. Additionally, the identifier may be used or linked to an authentication server/module associated with using the block chain as a communication channel, for performing security, authentication, resolving, or other actions.

In an embodiment of the present invention, the message 432 may include a digitally signed message checksum as way to verify the message. For example, the sender of the message may digitally sign a checksum or hash of the message using his or her private key. A receiving device can verify the integrity of the data by verifying the checksum or hash using the sender's public key. Those having skill in the art shall recognize that other methods for verifying the data's integrity may also be employed herein.

In at least one embodiment of the disclosed, a first utility token described herein may be designed as a decentralized ERC20 token on the Ethereum blockchain. Its use within the platform may have certain limitations depending on whether users are located in jurisdictions in which the platform management system is licensed to offer a full suite of betting services (i.e. Full Service Jurisdictions) or in jurisdictions where the platform may offer a more limited set of betting services (i.e. Limited Jurisdictions).

In Full Service Jurisdictions, the first utility token may be used for the exchange and interchange of a virtual point-based reward system for the purpose of legal and licensed betting on esports matches, tournaments and other engagement around gaming, including jackpot style games of chance. As designed, the first utility token may also be used as a rewards and incentive token for esports participants, players and teams through a tipping service. It may also be utilized, in another embodiment, for a spectator betting platform, and it may be used on a skill-based betting platform. In Limited Jurisdictions, the first utility token may be used to acquire jackpot tickets involving esports and for accessing exclusive rooms. The first utility token may serve as a utility token creating a decentralized, community-driven virtual economy. Transactions may be executed by a system of Ethereum smart contracts that are publicly accessible and that will be open and transparent to the network.

In parallel to the first utility token, a second utility token may be used within the ecosystem. While the second utility token may be limited in that it cannot be withdrawn from the platform, users, spectators, and players alike may be able to earn, bet and compete using the second utility token in any jurisdiction where the platform is offered.

In a further embodiment of the disclosed invention, the platform set forth provides users the ability to liquidate digital tokens through a provided market. The proposed ERC20 token may give alternative methods of possibly turning over their winnings on the Unikrn platform. An ERC20 token on the Ethereum blockchain offers additional functionality that is seldom found on a centralized token ecosystem.

A token that is built on an Ethereum-based utility token may dramatically increase usage and utility. While the disclosed utility token coincides with a skill-based betting product, fiat betting, where we are regulated and licensed, may also be offered concurrently along with a utility token.

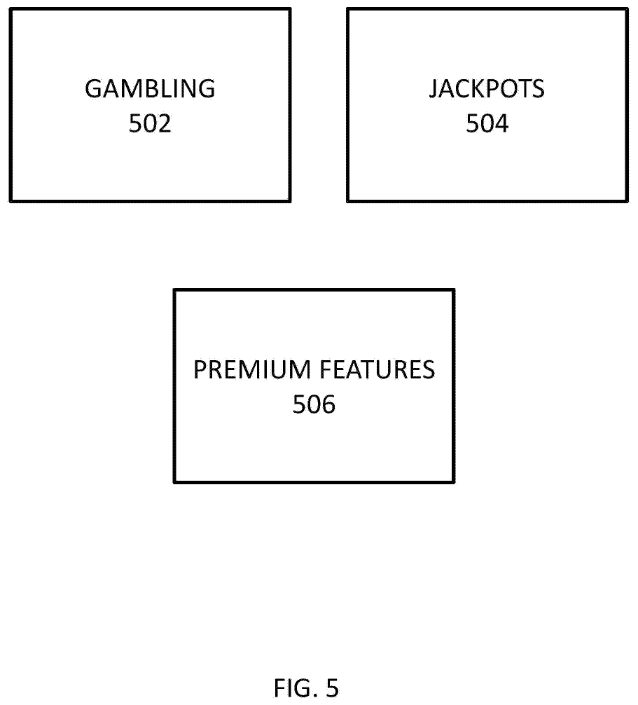

As shown in FIG. 5, a variety of products and/or services may be made available on the disclosed platform. The products/services provided include, but is not limited to gambling 502, jackpots 504, and premium features 506.

Gambling products 502 may include skill-based wagering and spectator-based gambling. The platform sports book, or esportsbook, may offer a wide selection of gambling markets on professional esports matches and tournaments. Further, the platform sports book may offer skill-betting products.

Jackpot products 504 may offer users or players the opportunity to acquire jackpot tickets to win prizes (ranging from in-game items such as skins, to gaming hardware and accessories from world-class manufacturers, or the like). Products 504 may also include exclusive jackpot rooms (“exclusive rooms”) with experiences only available to users who purchase certain tickets, such as golden entry tickets using one of the aforementioned utility tokens.

Premium features 506 may comprise a membership roadmap that includes the ability for users to earn one or more of the aforementioned utility tokens for playing and winning video games on one or more community servers. User wallets on the platform may be provided for the storage of crypto-currency tokens available on the platform. Digital wallets provide for the conducting of transactions quickly with little or no additional transaction fees. Users of the platform may be enabled to tip esports players/professionals using one or more crypto-currency tokens stored within a user's digital wallet.

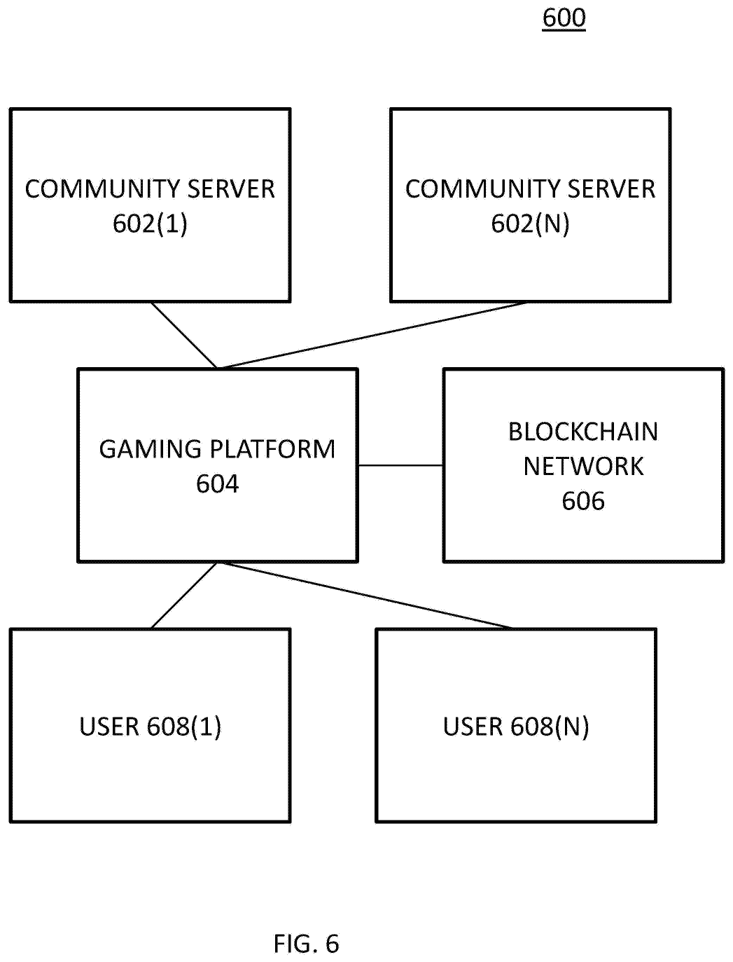

FIG. 6 provides a simplified, non-limiting overall diagram 600 of one or more disclosed embodiments. A plurality of Community servers 602(1) to 602(N) may be provided to facilitate interaction via Gaming Platform 604 between multiple users, USER 605(1) to USER 608(N). Gaming Platform 604 may be logically connected directly or indirectly via networking means to a Blockchain Network 606. While a single Blockchain Network is shown, it is understood that multiple blockchain networks may be utilized to conduct transactions of the underlying blockchain and cryptocurrency capabilities described herein and above. Users 608 may include spectators, basic users, premium users, amateur players, and professional players, etc (collectively, users).

One or more users may place bets or wagers for professional esports matches on an esportsbook provided by gaming platform 604. Users may be provided with the ability to play for crypto-currency in competitive skill-based video game matches hosted by the gaming platform 604 via community servers 602. Rewards may be provided via the platform's API (not shown). Further applications may include a next-generation spectator engagement application. Gaming Platform 604 may also provide access to premium subscription features such as rewards for performing various actions on the platform (e.g. connecting your gamer accounts, referring new customers, and access to premium written and video content.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. An electronic esports wagering platform comprising:
a network having connected thereto:
one or more community servers configured to provide one or more interactive features;
one or more devices operated by at least one or more users having associated with each of the one or more users a digital wallet for the storage of one or more types of crypto-currency tokens;
a blockchain network configured to execute one or more transactions and maintain a distributed ledger to record the executed one or more transactions;
a gaming platform connected to at least one blockchain network configured to:
provide one or more transactions based on one or more requests received from the one or more community servers, the one or more devices, or the gaming platform;
provide a gameplay between the one or more users;
handle one or more wagers made by the one or more users associated with the gameplay; and
execute one or more transactions in response to a result of the gameplay between the one or more users.

2. The electronic esports wagering platform of claim 1, wherein the digital wallet is configured to:
store one or more types of utility crypto-currency tokens; and
conduct one or more transactions via the at least one blockchain network;
wherein the one or more transactions are conducted quickly without transaction fees.

3. The electronic esports betting platform of claim 2, wherein the one or more transactions include tipping one or more of the other one or more users.

4. The electronic esports wagering platform of claim 3, wherein tipping includes the transfer of a set amount of the one or more types of utility crypto-currency tokens from a tipping user to a tipped user, the transfer conducted by the at least one blockchain network.

5. An esports wagering platform, comprising
a first utility crypto-currency token designed as a decentralized ERC20 token based on an Ethereum blockchain; and
a second utility crypto-currency token designed as a decentralized ERC20 token based on the Ethereum blockchain;
one or more users each associated with a digital wallet configured to store a value of the one or more of the first and second utility crypto-currency tokens.

6. The esports wagering platform of claim 5, wherein the first and second utility crypto-currency tokens have certain limitations of use depending on the location of the one or more users.

7. The esports wagering platform of claim 6, wherein the location of the one or more users are within jurisdictions in which a platform management system of the esports wagering platform is licensed to offer a full suite of wagering services or in jurisdictions where the platform is licensed to offer a limited set of wagering services.

8. The esports wagering platform of claim 7, wherein the first utility crypto-currency token is usable within an ecosystem of the esports wagering platform and is withdrawable from the esports wagering platform.

9. The esports wagering platform of claim 8, wherein the first utility crypto-currency token is usable for exchange between the one or more users and of a virtual point-based reward system.

10. The esports wagering platform of claim 7, wherein the second utility crypto-currency token is usable within an ecosystem of the esports wagering platform and is not withdrawable from the esports wagering platform.

11. The esports wagering platform of claim 10, wherein the second utility crypto-currency token is exchangeable for one or more products or services within the ecosystem of the esports wagering platform.

12. A method for providing a wagering platform, the method, with at least one computing device, comprising:
interconnecting, via a network, at least one gaming platform, a blockchain network, one or more user devices, and one or more community services;
receiving one or more wagers associated with gameplay between the one or more devices;
facilitating gameplay between at least two of the one or more devices; and
resolving the one or more wagers based on results of the gameplay.

13. The method of claim 12, wherein the one or more wagers is received from a user participating in the gameplay.

14. The method of claim 12, wherein the one or more wagers is received from a user not participating in the gameplay.

15. The method of claim 12, wherein the one or more transactions include a transfer of a wagered amount from a loser's associated crypto-currency account to a winner's associated crypto-currency account.

16. The method of claim 16, wherein each user account is managed by a digital wallet.

17. The method of claim 15, wherein the one or more transactions are executed by the blockchain network.

18. The method of claim 12, further comprising:
receiving a request to tip a certain amount from a first one of the one or more users to a second one of the one or more users.

19. The method of claim 18, wherein the certain amount is transferred via a transaction made by the blockchain network and viewable on the distributed ledger of the blockchain network.

20. The method of claim 12, wherein the one or more wagers are made using at least one of a first and second type of crypto-currency token, wherein the first type of crypto-currency token is withdrawable from the at least one gaming platform and the second type of crypto-currency token is not withdrawable from the at least one gaming platform.
